(19) United States
(12) Patent Application Publication
(10) Pub. No.: US 2005/0153707 A1
(43) Pub. Date: Jul. 14, 2005

(54) Portable service identification, notification and location device and method

(76) Inventors: Liza Ledyard, Dallas, TX (US); David Ingle, Durango, CO (US); Jay Bruce Ross, Lambertville, NJ (US)

Correspondence Address: HOWISON & ARNOTT, L.L.P, P.O. BOX 741715, DALLAS, TX, 75374-1715, US

(21) Appl. No.: 10/897,995

(22) Filed: Jul. 23, 2004

Related U.S. Application Data
(60) Provisional application No. 60/490,217, filed on Jul. 25, 2003.

(51) Int. Cl. H04B 7/00

(52) U.S. Cl. 455/456.1; 455/456.5

(57) ABSTRACT

A system and method for automated location of transportation vehicle passengers enables a passenger to request a transportation vehicle by activating a transceiver. The transceiver transmits a request signal upon activation to a transportation server. The transportation server sends a location request to a location system. The location system then transmits an interrogation signal from the location system to the transceiver. The transceiver responds by transmitting a response signal back to the location system. The location system then processes said response signal to determine the physical location of the transceiver and sends a pick-up signal to a transportation vehicle to pick up the passenger at the determined physical location.

This application claims benefit of Provisional Application U.S. Ser. No. 60/490,217, filed on Jul. 25, 2003 Dkt. No. MORI-26-071).

### TECHNICAL FIELD OF THE INVENTION

This invention is related to a method and system for token communication and payment, in particular for a token used in hailing a taxi, including automated passenger location and payment systems.

### BACKGROUND OF THE INVENTION

An extremely common and yet strikingly difficult transactions in modern society is engaging a taxicab. For the passenger, simply finding a taxi at a given time and place can be hard to accomplish. For the cab drivers, finding potential customers and knowing which ones can be trusted to make payment can add substantially to their costs.

There are several ways for a taxi to locate passengers. In one situation, a taxi waits at a high traffic location such as an airport or hotel. While the likelihood of finding potential passengers at these locations is high, the probability of success means that the wait for passengers is usually proportionally longer. Time spent waiting for a passenger is time lost to a taxi driver.

Alternatively, a taxi responds to calls from a dispatcher, which is responding in turn to calls received by passengers for pick-up. When a passenger at a location where taxi cabs are not simply waiting, the passenger calls a taxi company to request a cab. The passenger gives the taxi company identification information, such as their name, as well as the address where they need to be picked up from and possibly the destination they will need to be taken to. The taxi company dispatcher sends a request to one or more of the company taxis to identify an available cab. A taxi in the general vicinity of the passenger who is available responds to the dispatcher and proceeds to the pick-up location.

However, potential passengers are not always in a location where there is a readily available phone, making calling a taxi company problematic. Furthermore, passengers do not always know the address where they are located. Communication difficulties can make engaging a taxi more difficult than it needs to be.

Another method of engaging a taxi, in cities, is to stand on a busy street and hail the taxi as they approach. This method can be effective, but at other times is completely ineffective. One of the major problems with this sort of random pick-up is that it is riskier for the taxi drivers, both in terms of non-payment and violent crime. Since picking up someone off the street gives no identifying information at all, the dangers inherent to taxi driving is enhanced in this situation.

Therefore, a method and system for engaging a taxi cab, including the ability to locate the passenger, identify the passenger and arrange payment from the passenger, from any location is needed.

### SUMMARY OF THE INVENTION

The present invention disclosed and claimed herein, in one aspect thereof, comprises a system and method for automated location of transportation vehicle passengers by activating a transceiver to request a transportation vehicle. The transceiver transmits a request signal upon activation to a transportation server. The transportation server sends a location request to a location system. The location system then transmits an interrogation signal from the location system to the transceiver. The transceiver responds by transmitting a response signal back to the location system. The location system then processes said response signal to determine the physical location of the transceiver and sends a pick-up signal to a transportation vehicle to pick up the passenger at the determined physical location.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates the portable service identification, notification and location system;

FIG. 2 illustrates a protocol for using the portable service identification, notification and location system;

FIG. 3 illustrates another embodiment of the portable service identification, notification and location system;

FIG. 4 illustrates a protocol for using the portable service identification, notification and location system;

FIG. 5 illustrates another embodiment of the portable service identification, notification and location system;

FIG. 6 illustrates a passenger alert device;

FIG. 7 illustrates a schematic of the passenger alert device;

FIG. 8 illustrates another embodiment of the passenger alert device;

FIG. 9 illustrates another embodiment of the passenger alert device;

FIG. 10 illustrates a protocol for the location of the passenger alert device;

FIG. 11 illustrates a protocol for the payment function of the portable service identification, notification and location system;

FIG. 12 illustrates another protocol for the payment function of the portable service identification, notification and location system;

FIG. 13 illustrates another protocol for the portable service identification, notification and location system;

FIG. 14 illustrates the dispatch function;

FIG. 15 is a functional diagram of the portable service identification, notification and location system;

FIG. 16 illustrates a protocol for the pre-arranged function of the portable service identification, notification and location system;

FIG. 17 illustrates the location function of the portable service identification, notification and location system;

FIG. 18 illustrates the location system;

FIG. 19 illustrates another embodiment of the portable service identification, notification and location system;

FIG. 20 illustrates the cellular location system;

FIG. 21 illustrates a protocol for the assignment of a passenger alert device;

FIG. 22 illustrates a protocol for the registration of a passenger alert device;

FIG. 23 illustrates a more detailed protocol for the registration of a passenger alert device; and

FIG. 24 illustrates a block diagram of a portable service identification and notification system for a fixed location.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

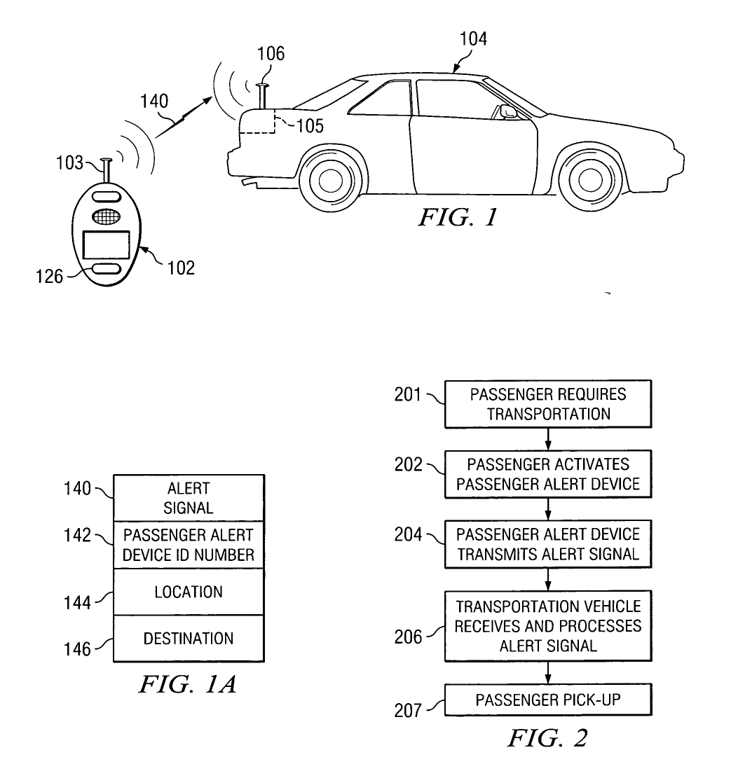

FIG. 1 depicts a simplified schematic of the portable service identification, notification and location system 100. A portable service identification, notification and location device 102 will generally be referred to as a passenger alert device or PAD. The passenger alert device 102, in accordance with the preferred embodiment is a specialized compact electronic transmitter. By pressing an input device 126 on the surface of the passenger alert device 102, the passenger alert device 102 is activated, causing the passenger alert device 102 to transmit a radio signal via antenna 103 that is received by a radio receiver 105 via antenna 106. Although antenna 103 is shown as being external to the casing of the passenger alert device 102, in the preferred embodiment the antenna 103 will be internal to the casing of the passenger alert device 102. The antenna 103 is shown external for illustration purposes, although it will be clear to those having skill in the art that the necessary requirements for the antenna will depend on the intended use and transmission and reception requirements of the specific device and operating environment.

As will also be apparent to those having skill in the art, the transmitter of the passenger alert device 102 and receiver 105 may be transceivers, capable of both transmission and reception.

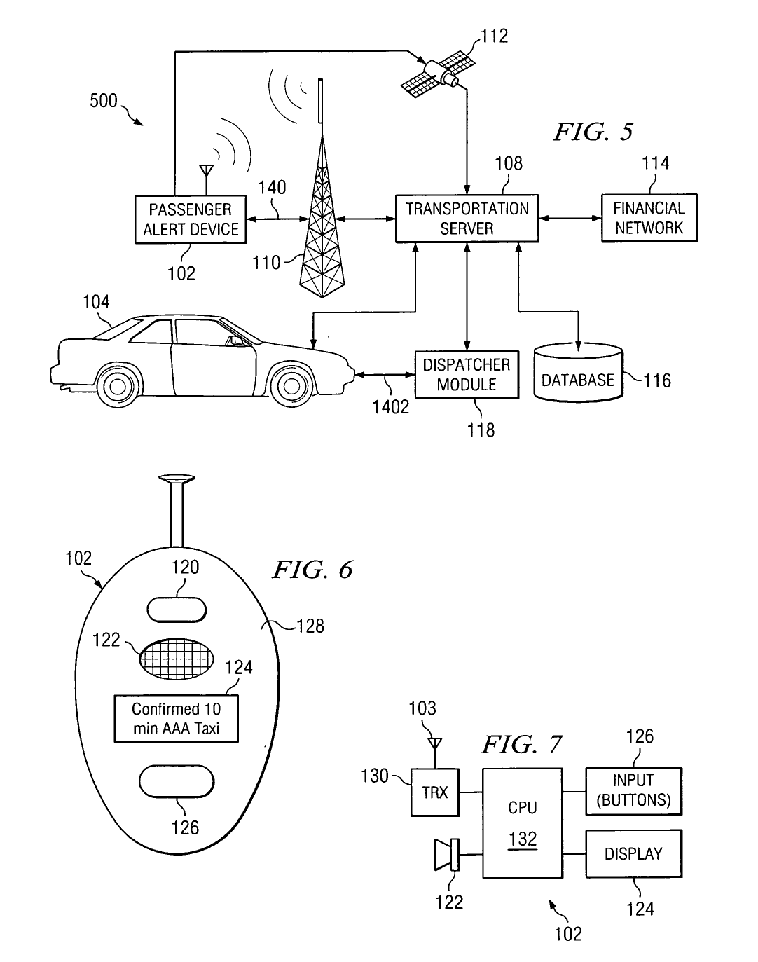

The signal transmitted by the passenger alert device 102 will be referred to as an alert signal 140. As shown in FIG. 1A, the alert signal may include the passenger alert device identification number 142. In the case of pre-arranged transportation systems, the alert signal may also optionally include the pick-up location 144 and the destination 146. Other information that may be useful to the system may also be included. In some embodiments of the invention, the information may be coded or linked to further information found in a database 116 (see FIG. 5) accessible to the receiver 105.

In operation, the alert signal 140 is received by a radio receiver 105 located in a transportation vehicle 104. The radio receiver 105 may include processing systems to receive the alert signal 140, derive information from the alert signal 140, connect to a database 116 (see FIG. 5) for accessing further information linked to the data in the alert signal 140 and/or display information to driver of the transportation vehicle 104.

The transportation vehicle 104 may be an automobile such as a taxicab or limousine. As will be recognized by those having skill in the art, the transportation vehicle 104 could conceivably be any form of transportation vehicle including a bus. For purposes of this description but in no way intending to limit the invention, the transportation vehicle 104 may be referred to as a taxi, a taxicab or a cab. In accordance with the preferred embodiment, the transportation vehicle 104 will be a vehicle for hire for what is usually the duration of a single ride. Alternatively, the transportation vehicle could be one that is hired for longer periods of time, or even a vehicle owned by the passenger. The key aspect to the portable service identification, notification and location system is that the transportation vehicle is driven by someone other than the passenger, who may be called to pick up and deliver the passenger.

FIG. 2 shows a representation of a protocol 200 of the portable service identification, notification and location system 100 as shown in FIG. 1. When a passenger requires transportation 201, the system functions are initiated when the passenger activates the passenger alert device in step 202. In accordance with the preferred embodiment, the activation of the passenger alert device 102 is accomplished by pressing an input device 126. Other forms of activation may be appropriate, depending on the specifics of the device embodying the passenger alert device 102. When the passenger alert device 102 has been activated, the passenger alert device 102 transmits an alert signal 140 at step 204.

The alert signal 140 contains information regarding the passenger alert device 102. The alert signal 140 may contain such information as the identity of the passenger, pick-up location, destination and/or payment information directly. Alternatively, the alert signal 140 may contain a passenger alert device ID, which may be correlated to a database 116 (see FIG. 5) including such information as passenger identity, pick-up location, destination location and/or payment information.

In accordance with the preferred embodiment, the transmission of the alert signal 140 is accomplished by radio transmission. As will be recognized by those having skill in the art, other forms of information transmission could be used in the alternative, depending on the specific uses and requirements of the specific system environment. In particular, when the passenger alert device 102 is designed for use in a situation where the passenger alert device 102 is usually activated in close proximity to the transportation vehicle 104, the transmission methods that may be used will encompass a much wider range of possibilities including audible and optical or infrared transmission systems. As will be apparent to those having skill in the art, it will be necessary in these alternate embodiments, however, that the transportation vehicle 104 be equipped with an appropriate receiving device 105 so that the alert signal 140 from the passenger alert device 102 can be received.

Instep 206, the transportation vehicle 104 receives the alert signal 140 from the passenger alert device 102. The transportation vehicle 104 may read passenger identity information, pick-up location, destination and/or payment information from the alert signal, or may read the passenger alert device ID from the alert signal and by correlating the passenger alert signal ID with information stored in an accessible database 116 (see FIG. 5) discover the required information. In step 208, the transportation vehicle 104 drives to the pick-up location, which may be designated by pre-arrangement for the specific passenger alert device 104 or otherwise predetermined. The transportation vehicle approaches the passenger and identifies them either electronically or otherwise. The passenger is picked up by the transportation vehicle 104 for transportation to the passenger's desired destination.

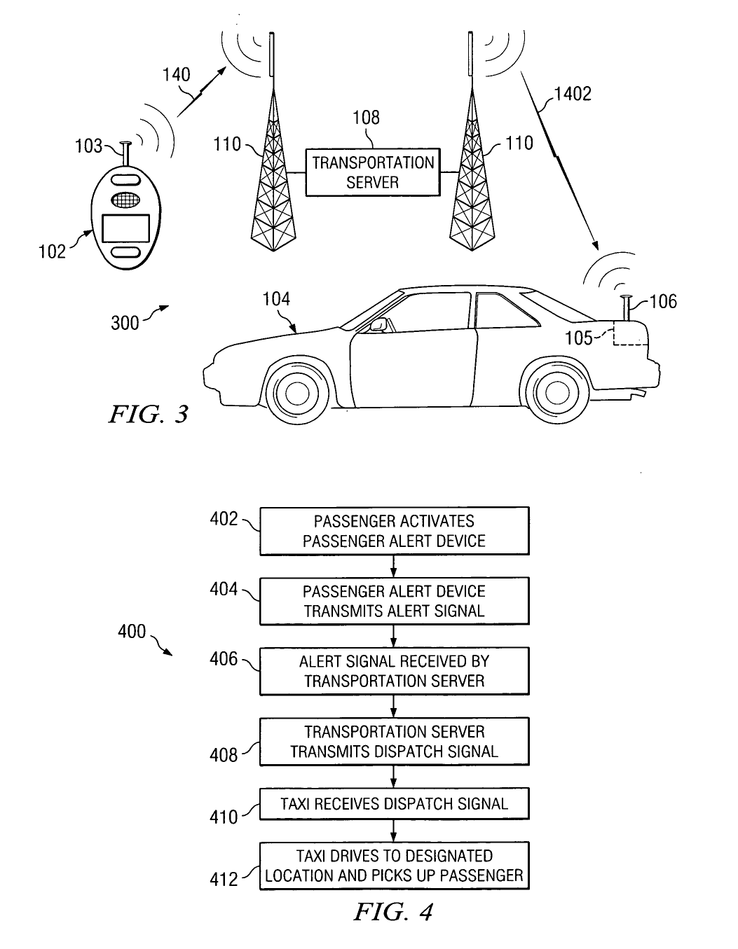

FIG. 3 depicts another embodiment of a portable service identification, notification and location system 300 using the passenger alert device 102. The system 300 includes a communication network 110, typically a fixed cellular radio network designed for local radio reception and transmission. The communication network 110 is further connected to a transportation server 108. The communication network 110 will generally include one or more antenna, receivers and transmitters, and other communication elements known in the art. The transportation server 108 communicates via the communication network 110 with the transportation vehicles 104. In this manner, the transportation server 108 coordinates the transportation system serving the passenger alert device 102 and the transportation vehicle 104.

FIG. 4 shows a representation of a protocol 400 for the portable service identification, notification and location system 300 shown in FIG. 3. When a passenger requires transportation, 402, the passenger initiates the process by activating the passenger alert device 102. In accordance with the preferred embodiment, the passenger activates the passenger alert device 102 by pressing a button 126. However, as will be recognized by those having skill in the art, the activation of the passenger alert device may be accomplished by other appropriate means, depending on the specific configuration of the passenger alert device 102. In step 404, when the passenger alert device 102 has been activated, the passenger alert device 102 transmits an alert signal 140. The alert signal 140 is received via the communication network 110 in step 406, communicated to and processed by the transportation server 108. When the alert signal has been processed by the transportation server 108, the transportation server 108 transmits a dispatch signal 1402 (see FIG. 14) in step 408. The transportation vehicle 104 receives the dispatch signal 1402 from the transportation server 108 in step 410. The transportation vehicle 104 then drives to a designated pick-up location and approaches a passenger for pickup and delivery to the passenger's desired destination in step 412.

FIG. 5 depicts a multi-featured portable service identification, notification and location system 500 using a passenger alert device 102. The portable service identification, notification and location system 500 includes a communication network 110. Although the communication network 110 is represented by a single antenna, it should be recognized that the communication network 10 may include any number of antenna, microwave antenna, receivers, transmitters, transceivers, processors, relays, landlines, optical fibers and other known elements of a communication network. In the preferred embodiment, the telecommunication network 10 utilizes a cellular telephone network.

The system 500 also include a satellite communication network 112. The satellite communication network 112 may be used alone or in conjunction with communication network 110 to determine the physical location of the passenger alert device 102. The communication network 110 and the satellite communication network 112 are in communication with transportation server 108. The transportation server is further in communication with a financial network 114, a database 116 and a dispatcher module 118.

It will be recognized by those having skill in the art that the transportation server may be connected either directly or indirectly by virtual or network resources to the communication network 110, the satellite network 112, the financial network 114, the database 116 and the dispatcher module 118. In addition, one or more of the processes, including the financial network 104, the database 116 and the dispatcher module 118 may actually be processes executing on the computer which is also executing the transportation server 108. It will be recognized by those having skill in the art that each of these components may be distinguished from the transportation server 108 by function. In this manner, the financial network 114 may comprise a computer or a computer network located remotely from the transportation server, or the functions of the financial network may actually be performed by the computer that makes up the transportation server 108. The dispatcher module 118 and the transportation server 108 are in communication with the transportation vehicle 104.

The passenger alert device 102 is configured to send an alert signal 140 when the passenger alert device 102 is activated. In some embodiments, passenger alert device 102 may also respond to signals sent from the communication system 110 or the satellite communication system 112. The response may be automatically triggered by processes functioning within the passenger alert device 102 or by passenger input. The alert signal identifies the passenger alert device 102 to the transportation server 108. Further signals are used to locate the passenger alert device 102, and may be used to perform other functions such as authorization. The transportation server 108 coordinates the various functions performed by the system in response to an alert signal from the passenger alert device, including initiating the location system 1504, arranging the transportation vehicle 104 for pick-up through a dispatcher 118, processing the passenger identity information in a database 116 and arranging payment with a financial network 114 to pay the transportation vehicle 104 for the ride.

One possible use of the portable service identification, notification and location system is to provide transportation for a passenger who is intoxicated. The passenger, or a friend of the passenger, presses the activation button 126 on the passenger alert device 102. The display 124 may then flash a message such as “Request Taxi” so that the passenger is aware that the request is being processed. An alert signal 142 is sent to the transportation server 108 via the communication network 110.

In response to the alert signal, the transportation server 108 retrieves the passenger alert device configuration file from the database 116 and sends a location request to the location system 1504. The location system 1504 locates the passenger alert device 102 and sends a location signal to the transportation server 108. The transportation server 108 sends a dispatch order 1402 to the dispatcher module 118. The dispatch order may include paging data for communication with the passenger alert device 102, billing information or a pre-approved payment and tip, the destination and the name of the passenger and a pass code. The dispatch module 118 then sends a dispatch order 1402 to a transportation vehicle 104. The dispatcher module 118 send a confirmation message to the transportation server, indicating the receipt of the dispatch order 1402 and anticipated time of pick-up. The transportation server 108 sends a confirmation message to the passenger alert device, in audio or for visual display or a combination of the two, including expected time of pick-up and the pass code for verification of the passenger identity.

FIG. 6 depicts a first embodiment of the passenger alert device 102. In this first embodiment, the passenger alert device 102 is fashioned as a key fob that can be attached to a key chain. In accordance with the preferred embodiment, the passenger alert device 102 is designed to be approximately 2 1/4 inches long, 1 1/2 inches wide and less than ½ inch thick. The passenger alert device 102 includes an outer shell 128. The outer shell 128 of the first embodiment is composed primarily of a rigid substance such as plastic. Other materials may be suitable for different configurations of the passenger alert device 102. In the first embodiment, a chain hole 120 is fashioned at one end of the passenger alert device 102, for the insertion of a key chain. A speaker 122 is positioned on the upper surface of the outer shell 128. The speaker 122 is used to create audible signals such as beeps to notify the passenger of inputs or incoming signals, or for the transmission of voice signals. A digital display 124 is located on the upper surface of the outer shell 128, for the representation of transmitted and internally generated information. A button 126 appears on the upper surface of the outer shell 128. Pressing the button 126 activates the passenger alert device 102.

With reference to FIG. 7, a functional schematic of the passenger alert device 102 is shown. The passenger alert device 102 includes a transceiver module 130. The transceiver module 130 is designed to communicate by radio transmission signals via antenna 103. The transceiver 130 communicates with a central processing unit 132. The central processing unit 132 may be a general purpose microprocessor computing device or may be a specialized circuit for performing specific functions as needed by the passenger alert device 102. The central processing unit 132 is also in communication with one or more input devices 126. In the preferred embodiment, the input devices 136 will consist of buttons for pressing. Other embodiments may lend themselves more readily to alternative input devices. The central processing unit 132 is connected to outputs such as display 124 and a speaker 122. The display 124 may be as simple as a single LED or a full digital LCD screen. The choice of input devices 126 and output displays 124 may depend on other functions to be performed by the particular embodiment of the passenger alert device 102.

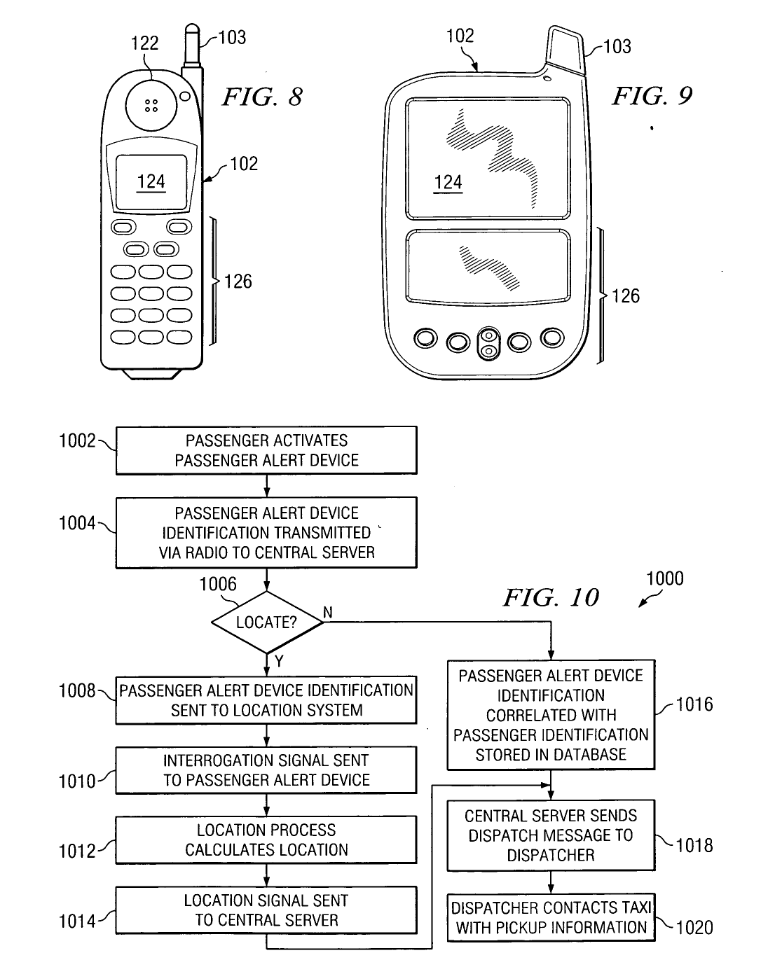

With references to FIGS. 8 and 9, some alternative embodiments of the passenger alert device are shown. FIG. 8 depicts a standard cellular telephone unit. The cellular telephone circuits (not shown) of the cellular telephone are used as the transceiver 130 and processor 132 in this particular embodiment of the passenger alert device. The buttons of the cellular telephone act as the input devices 126. The cellular telephone passenger alert device 102 includes a speaker 122, antenna 103 and a display 124. To activate the passenger alert device functions on a passenger alert device in accordance with this embodiment, a specialized passenger alert device button may be pressed. Alternatively, a sequence of buttons may be used to activate the passenger alert device functions and send an alert signal. A menu system using the display 124 to show options may be used to simplify the activation process.

FIG. 9 depicts a wireless PDA configured for use as a passenger alert device. A modem (not shown) is connected to a cellular transceiver connected to the antenna 103 acts as the transceiver 130. Buttons and a touch screen form the input devices 126. The LCD screen of the PDA acts as the display 14. This particular embodiment may not include a speaker 134. To activate the passenger alert device functions on a passenger alert device in accordance with this embodiment, a specialized passenger alert device button may be pressed. Alternatively, a sequence of buttons may be used to activate the passenger alert device functions and send an alert signal. The touchpad, used in conjunction with a stylus to select and activate the passenger alert device functions. A menu system using the display 124 to show options may be used to simplify the activation process. In response to activation, an alert signal is sent via transceiver 130 and antenna 130.

FIG. 10 depicts a protocol for the location of a passenger using the portable service identification, notification and location system 1000. When a passenger wants to request a transportation vehicle, the passenger activates the passenger alert device 102. In step 1004 the passenger alert device 102 transmits an alert signal 140 including a passenger alert device ID number 142 via a communication network 110 to the transportation server 108. The transportation server processes the passenger alert device ID 142 in step 1006 to determine whether or not the passenger's location has been predetermined and programmed into the configuration of the passenger alert device 102, or if the passenger alert device 102 configuration is such that the passenger requires location determination.

If the passenger alert device is configured to require location determination, in step 1008 the passenger alert device identification number 142 is sent by the transportation server 108 to the location system 1504. In step 1010 the location system 1504 sends an interrogation signal to the passenger alert device 102. The passenger alert device 102 may respond to the interrogation signal with a response signal, depending on the location system parameters. In step 1012, the location system using details of the interrogation and response signal initiates a location process to calculate the location of the passenger alert device 102. The determined location may be in the form of a city-street-address or any other form of coordinates appropriate to the environment and system. The key aspect of the determined location is that the values can be used by the transportation vehicle to physically locate the passenger.

In step 1014, the location system 1504 sends a location signal including the determined location values to the transportation server 108.

In the case where the passenger alert device 102 has been configured for providing transportation between pre-arranged fixed locations, it may not be necessary for the system to initiate the location process and instead use values stored in the passenger alert device configuration files of database 116. If the passenger alert device 102 is configured so that its location is predetermined, the received passenger alert device identification number 142 is correlated with the passenger identification configuration data stored in the database 116 in step 1016 to retrieve the predetermined location values.

In step 1018, the transportation server 108 generates and sends a dispatch order 1402 to the dispatcher module 118. In some systems, the transportation server 108 may send the dispatch order 1402 directly to the transportation vehicle 104. In step 1020 the dispatcher module 118 transmits the dispatch 1402 to the transportation vehicle 104. The dispatch order 1402 includes the location values 1406. The transportation vehicle 104 processes the dispatch order to determine the location values and then proceeds to the location where the passenger alert device is located to pick up the passenger and deliver them to their desired destination.

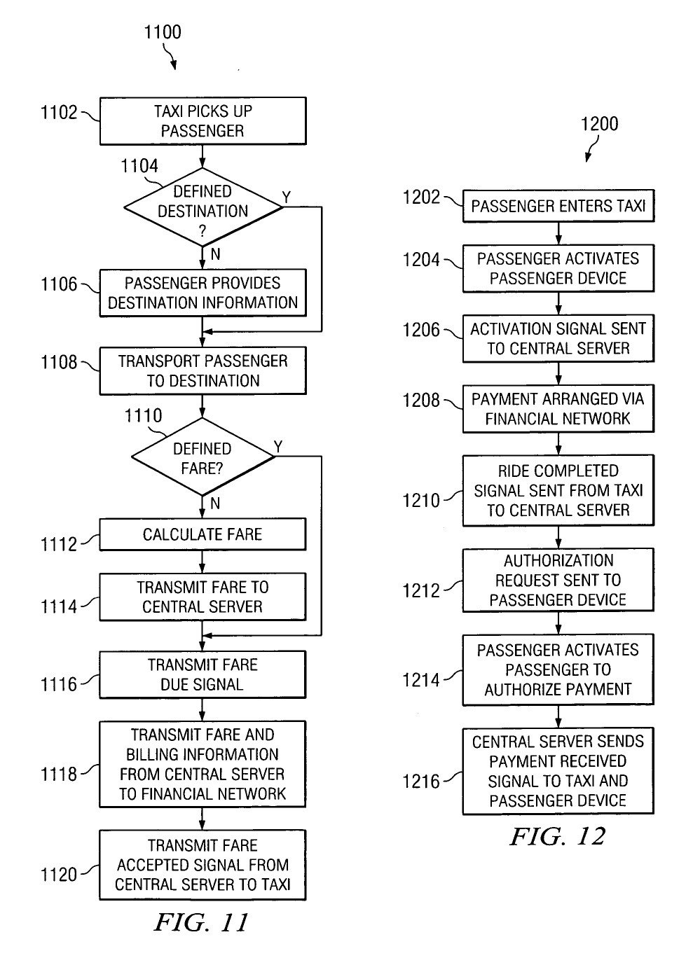

FIG. 11 represents a protocol 1100 for arranging payment in the portable service identification, notification and location system. In step 1102 the transportation vehicle 104 picks up a passenger for delivery to a desired destination. In step 1104 the transportation vehicle 104 processes the dispatch order 1402 to determine if the destination of the passenger has already been defined in the destination field 1408 of the dispatch order. In the case where the passenger alert device 102 has been configured for providing transportation between pre-arranged fixed locations, pre-defined destination values may be stored in the passenger alert device configuration files of database 116.

If the destination has been prearranged and defined in the dispatch order, the transportation vehicle processes the destination and transports the passenger to the desired destination in step 1108. If the destination is not predefined in the dispatch order 1402 then the passenger provides destination information to the transportation vehicle driver in step 1106.

The driver of the transportation vehicle 104 also processes the dispatch order 1402 to determine if the fare 1414 for the trip has been predetermined in step 1110. In the case where the passenger alert device 102 has been configured for providing transportation between pre-arranged fixed locations, pre-defined fare values may be stored in the passenger alert device configuration files of database 116.

If the fare has not been predefined in the passenger alert device configuration files and included in the dispatch order 1402, the fare is calculated in step 1102 by the driver of the transportation vehicle 104 and the calculated fare is transmitted to the transportation server in step 1114. In step 1116 a fare signal is sent to the transportation server 108 indicating to the transportation server 108 that the fare has been earned and that the passenger's account should be charged. The transportation server 108 in step 1118 then transmits the fare and billing information from the transportation server 108 to the financial network 114. When the fare has been processed by the financial network 114, a fare accepted signal is transmitted from the transportation server 108 to the transportation vehicle 104 in step 1120.

FIG. 12 represents a protocol 1200 for arranging payment for transportation services using a portable service identification notification and location system. When the passenger uses a transportation vehicle waiting at a taxi stand, the passenger enters the transportation vehicle 104 in step 1202 and begins the trip to the destination. In order to arrange payment, the passenger activates the passenger device 102 in step 1204 and an alert signal 140 is sent to the transportation server 108 in step 1206. The transportation server 108 sends a fare signal along with billing information to the financial network 114 arranging payment for the trip in step 1208. A ride completed signal is sent from the transportation vehicle 104 to the transportation server 108 in step 1210 and authorization request is sent to the passenger alert device 102 in step 1212. The passenger activates the passenger alert device 102 to authorize payment in step 1214 and the transportation server 108 sends a payment received signal to the transportation vehicle 104 and the passenger alert device 102 in step 1216.

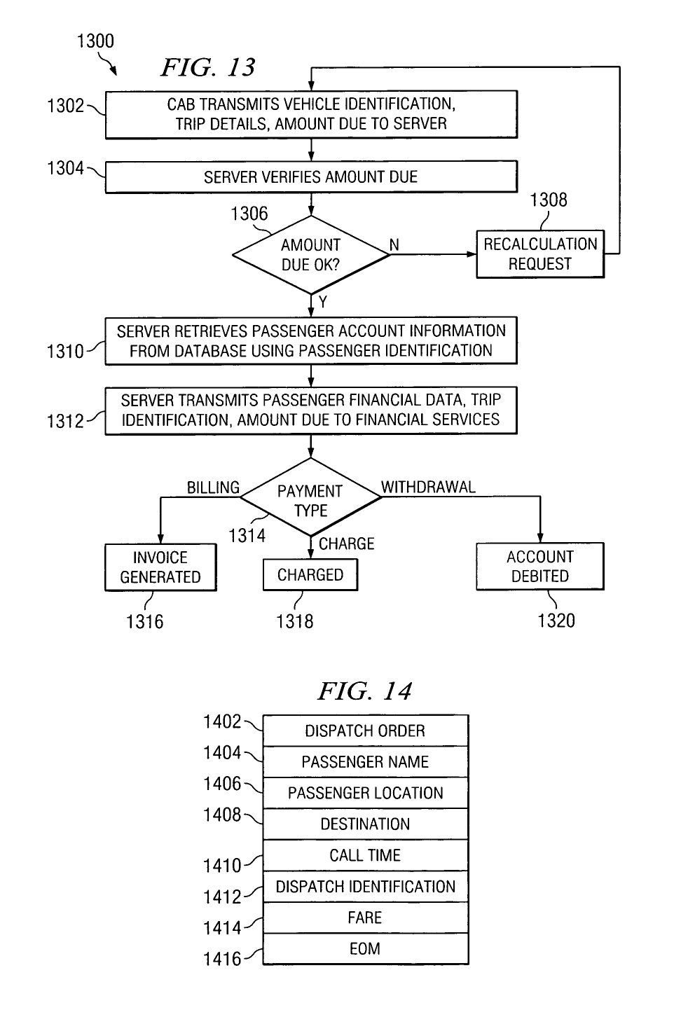

FIG. 13 represents a protocol for the payment function of the portable service identification, notification and location system. In step 1302, the transportation vehicle 104 transmits a vehicle identification number along with any pertinent trip details along with a calculated amount due to the transportation server 108. In step 1304, the transportation server 108 verifies the amount due, using the trip details. In step 1306, the transportation server 108 determines that the transmitted amount due matches the verified amount due calculation. If the calculated amount due does not match the verified amount due, then a recalculation request is sent to the transportation vehicle 104 in 1308. If the calculated amount due matches the verified amount due, then the transportation server 108 retrieves passenger account information from the database 116 using the passenger alert device identification number 142 sent in the alert signal 140 by the passenger alert device 102 in step 1310. In step 1312, the transportation server 108 transmits passenger account data, a trip identification number, an amount due to the financial services 114 in step 1312.

Step 1314 determines the payment type authorized for the passenger, as indicated in the passenger account information. If the payment type is set up for billing, then in step 1316 the fare amount is charged to the passenger account. Ultimately, an invoice is generated and sent to the passenger's billing address in the passenger alert device configuration data stored in database 116. In the case where the passenger alert device is registered to a corporate customer, the invoice will be sent to the corporate customer for payment.

If the payment type is designated as a credit charge, then the credit account identified in the passenger alert device configuration data stored in database 116 is charged in step 1318. If the payment type is designated as an account withdrawal, then the bank account identified in the passenger alert device configuration data stored in the database 116 is debited in step 1320.

FIG. 14 represents a dispatch order for use with the portable service identification, notification and location system. The transportation vehicle 104 receives a dispatch order 1402 from the dispatcher module 118. The dispatch order 1402 includes information necessary for the transportation vehicle 1402 to perform its transportation function. In particular the dispatch order may include such information as the pick up location 1406 and the passenger name 1404.

In accordance with the preferred embodiment of the dispatch order 1402, the dispatch order 1402 includes a field containing the passenger name 1404. The passenger name may be included in the dispatch order 1402 to provide the transportation vehicle the ability to discriminate between potential passengers, so that the passenger making the request is actually provided with transportation in a timely fashion. In cases where the passenger alert device 102 has been configured for transportation between predefined locations, or for a predefined pick-up location, the passenger location field may contain pick-up location data 1406. Similarly, the destination field 1408 may include values defining a predefined destination. A call-time field 1410 allows the transportation vehicle and transportation vehicle company to determine the timeliness of the service. A dispatch identification field 1412 is used to distinguish between particular dispatch orders. A fare field 1414 is used when a predefined fare has been established for a particular passenger and transportation. Finally, an end-of-message (EOM) field 1416 is used to indicate the end of a dispatch order 1402.

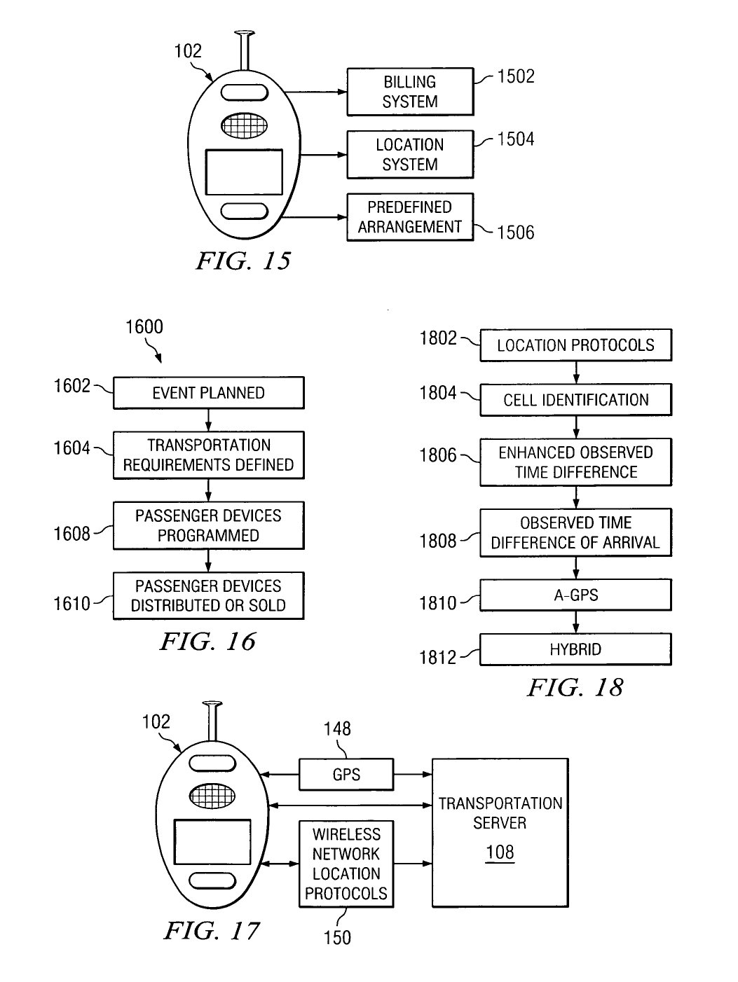

FIG. 15 is a schematic diagram of the functions of the portable service identification, notification and location system. The passenger alert device 102 communicates with, via the communication network 110 and the transportation server 108, a billing system 1502, a location system 1504 and predefined arrangements data 1506.

FIG. 16 represents a predefined arrangement agreement protocol for the portable service identification, notification and location system. The predefined arrangement protocol is particularly useful in conjunction with a special event when a need transportation between two locations is anticipated, such as between the airport and a convention center. For such an occasion, pre-programmed passenger alert devices can be distributed or sold to event participants, facilitating their specific transportation needs. Because the use of the distributed passenger alert devices could create a monopoly for a single transportation provider, the transportation services required could be offered at a substantial discount to event planners and participants. Similarly, the predefined arrangement protocols could be used to provide pre-programmed passenger alert devices to hotels and other venues where transportation to pre-defined destinations are anticipated, such as transportation for visitors back to a hotel. When a guest plans an excursion from a hotel, they could purchase or be provided with a passenger alert device that permits them to call a taxi from anywhere in the city to bring them back to the hotel.

For example, when an event is planned 1602, the transportation vehicle requirements for the event are defined in step 1604. In step 1608, the passenger alert devices 102 are programmed with the transportation requirements. The configuration data of the passenger alert devices may be programmed with pick-up locations, destination locations and pre-defined fare data. In step 1610 the passenger alert devices are distributed to the authorized users or sold to potential users.

FIG. 17 is a schematic diagram representing the location system function of the portable service identification, notification and location system. In a global positioning system (GPS) location system 148, the passenger alert device 102 receives signals from two or more satellites in a global positioning system 148. Using GPS processing systems, the passenger alert device 102 calculates the passenger alert device position coordinates and transmits them to the transportation server 108.

In another embodiment, the passenger alert device 102 receives interrogation signals from a a wireless network location system 150. The passenger alert device 102 send response signal back to the wireless network location system which uses the interrogation and response signal data to calculate the position of the passenger alert device 102. The wireless network location system 150 sends location signals representing the physical location of the passenger alert device 102 to the transportation server 108.

FIG. 18 represents the various location protocols 1802 of the location system 1504. The location protocols may include a cell ID protocol 1804, enhanced observed time difference 1806, and observed time difference of arrival protocols 1808. The location protocols may also include a global positioning system 1810. The location protocols furthermore may include a hybrid of the above-mentioned protocols 1812.

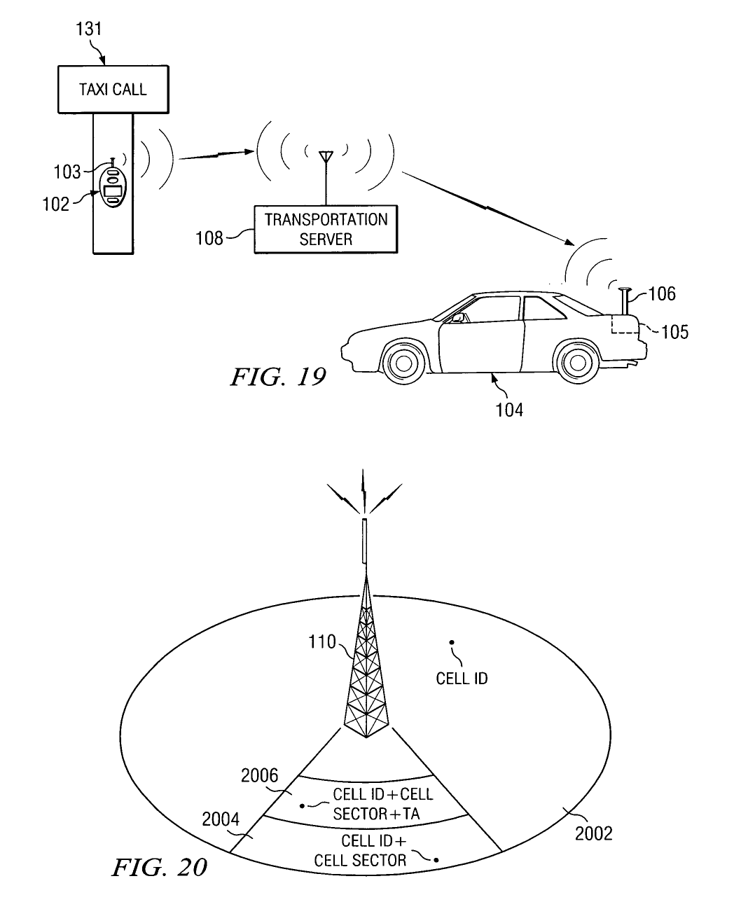

FIG. 19 represents another embodiment of the portable service identification, notification and location system. In accordance with this embodiment, the passenger alert device 102 is fixed at a physical location, such as a taxi call 131. In this embodiment, the location of the passenger alert device 102 is predetermined, and no information is available about the identity of the passenger. By placing the passenger alert device 102 in a location where transportation is occasionally required, such that passengers can activate the passenger alert device 102 to request a transportation vehicle, the resources of the transportation vehicle service can be optimized, allowing the transportation vehicles to service the location only when passengers are present. Furthermore, passengers are not required to have their own communication resources, nor know the identity or telephone number of any particular transportation service. Simply by pressing a button at the taxi call stand, transportation can be arranged.

FIG. 20 represents a cellular location protocol. A fixed transmitter 110 can locate a passenger alert device 102 using cell ID to fix the passenger alert device as being within area 2002. Using cell ID in addition to a cell sector location, the location of the passenger alert device 102 can be narrowed down to area 2004. Using cell ID with cell sector and a time of arrival calculation, the location of the passenger alert device 102 is narrowed down to the area defined as 2006.

Cell-ID operates in GSM (Global Standard for Mobile Communications), GPRS (General Packet Radio Service) and WCDMA (Wavelength Code Division Multiplexing Access) networks and is the simplest way to describe the general location of a transceiver, such as the passenger alert device 102. The communication network identifies the base station to which the passenger alert device 102 is communicating and the location of that base station. If the information is available, the Cell-ID location identifies the passenger alert device 102 locations as the location of the base station and passes the information to the location service application.

Since the passenger alert device 102 can be anywhere in the cell, the accuracy of Cell-ID depends on the cell size and can be poor in many cases since the typical GSM cell is anywhere between 2 km and 20 km in diameter. Further reducing the cell area by specifying the cell sector is a typical strategy to improve accuracy.

Enhanced Observed Time Difference (E-OTD) location systems operate in GSM and GPRS networks. In GSM, the passenger alert device 102 monitors transmission bursts from multiple neighboring basestations and measures the time shifts between the arrivals of GSM frames from the base stations to which it is communicating. These observed time differences are the underlying measurement of the E-OTD radio-location method and are used to trilaterate the position of the mobile device.

The accuracy of the E-OTD method is a function of the resolution of the time difference measurements, the geometry of the neighboring base stations and the signal environment. The passenger alert device must measure time differences from at least three base stations to support two-dimensional position determination.

Observed Time Difference of Arrival (OTDOA) operates only in WCDMA networks. The OTDOA location system estimates the position of the passenger alert device by referencing the timing of signals as they are received at the UE from a minimum of three Node B stations. The passenger alert device position is at the intersection of at least two hyperbolas defined by the observed time differences of arriaval of the WCDMA frames from multiple Node B stations.

Wireless Assisted GPS (A-GPS) operates on GSM, GPRS and WCDMA networks. A-GPS uses satellites in space as reference points to determine location. By accurately measuring the distance from the three satellites, the receiver triangulates the position anywhere on earth. The receiver measures distance by measuring the time required for the signal to travel from the satellite to the receiver. This requires precise time information, so in practice, measurements from a fourth satellite are required to help resolve time measurement errors created by the inaccuracies of inexpensive timing circuits typically used in portable devices.

A-GPS hybrids operate on GSM, GPRS and WCDMA networks, although compatibility depends on the other location technology being used with the A-GPS technology. Hybrid location technology combines A-GPS with other location positioning in a way that allows the strengths of one to compensate for the weaknesses of the other to provide more reliable and robust location solutions.

The most common implementation of Hybrid technology for GSM, GPRS and WCDMA networks is to combine A-GPS with Cell-ID. This improves yield in areas where A-GPS cannot produce position information and provides the accuracy of A-GPS in all other cases.

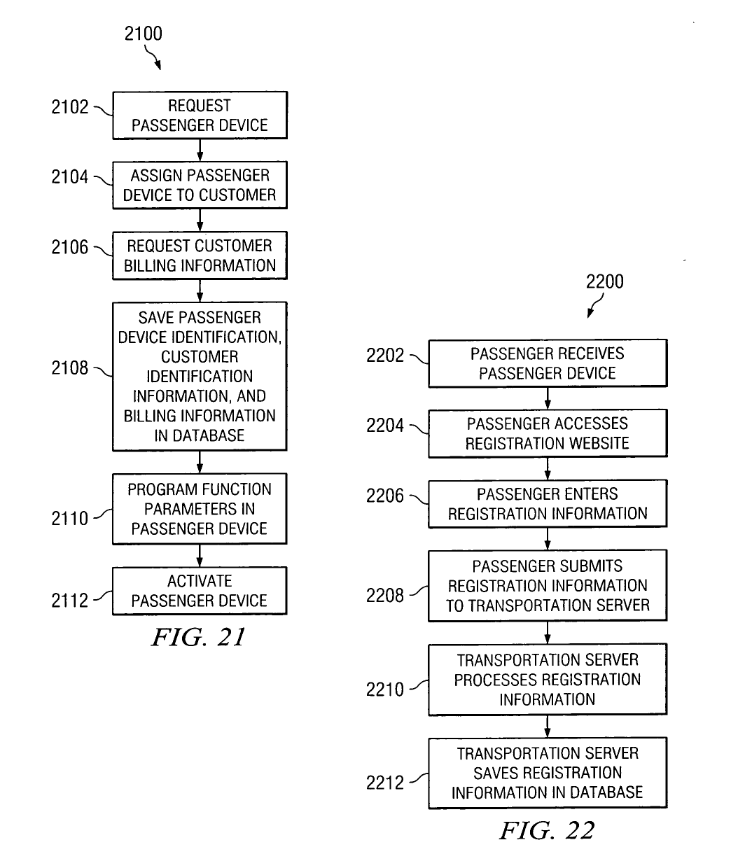

FIG. 21 represents a protocol for assigning a passenger alert device 102 to a customer. In step 2102, a customer requests a passenger alert device 102. The passenger alert device 102 is assigned to a customer in step 2104. The customer's billing information is requested and recorded in step 2106. In step 2108, the passenger alert device ID, the customer ID information and billing information are saved in a database 116. In step 2110, the function parameters are programmed into the passenger alert device 102. In step 2112, the passenger alert device 102 is placed in service.

FIG. 22 represents a protocol for the registration of a passenger alert device 2200. In step 2202, a passenger receives a passenger alert device 102. The passenger then accesses the registration website in step 2204. At the registration website, the passenger enters registration information in step 2206. A passenger submits registration information to the transportation server 108 in step 2208. The transportation server 108 processes the registration information in step 2210 and the transportation server saves the registration information in the database in step 2212.

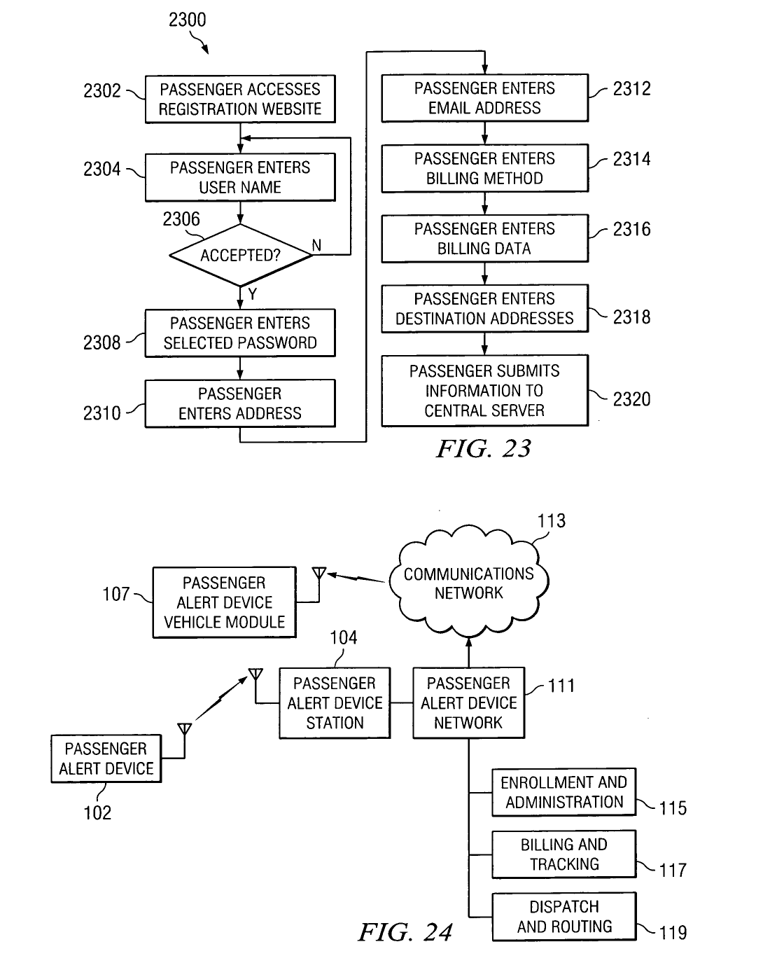

FIG. 23 represents a more detailed protocol for the collection of registration information 2300. In step 2302, the passenger accesses the registration website. The passenger enters a user name in step 2304. The transportation server 108 determines if the user name is acceptable in step 2306 and if the user name is not acceptable, the passenger is prompted to enter a new user name again in step 2304. If the user name has been accepted in step 2306, the passenger enters a select password in step 2308. In step 2310, the passenger enters the passenger's billing address. In step 2312, the passenger enters an e-mail address. In step 2314, the passenger selects the passenger's desired billing methods. In step 2316, the passenger enters billing data. In step 2318, the passenger enters destination addresses and finally in step 2320 the passenger submits the information to the transportation server 108.

With reference to FIG. 24, another embodiment of the portable service identification system is shown. In the present embodiment, the passenger alert device 102 may be a passive RFID transmitter which transmits a passenger identification number when it receives an activation signal from passenger alert device station 109. The passenger may be required to press an activation button to cause the passenger alert device to transmit the passenger identification number. Alternatively, the passenger alert device 102 may be an active RFID transmitter which transmits a passenger identification number when an activation button is depressed.

Passenger alert device station 109 is typically at a fixed location, communicably connected to the passenger alert device network 111. The passenger alert device station 109 includes a receiver and may include processing and storage capacity for managing the queue of passengers that may develop. The passenger alert device station 109 will generally be located in places where there is significant taxi traffic, such as hotels, event centers, convention centers, bars, restaurants, shopping facilities, airports or other suitable locations. The passenger alert device station 109 receives alert signals from the passenger alert device 102.

The passenger identification number received by the passenger alert device station 109 is sent to the passenger alert device network 111. The passenger alert device station 109 is typically connected by a fixed communication line such as a telephone connection, although any type of communication sufficient for relaying the necessary information may be used. The passenger alert device network 111 uses the passenger identification information to determine the identity of the passenger.

The passenger alert device network 111 communicates with systems to manage enrollment and administration 115, billing and tracking 117 and dispatch and routing 119. These systems may be implemented on the same machines as the passenger alert device network 111, or may be independent systems communicably connected to the passenger alert device network 111. The enrollment and administration system 115 manages the passenger accounts and other information relating to the passenger. The billing and tracking system 117 manages passenger payments. The dispatch and routing system 119 manages the taxicabs.

When the passenger alert device network 111 receives passenger identification information from a passenger alert device station 109, the passenger alert device network 111 sends a dispatch signal via the communications network 113 to a passenger alert device vehicle module 105. The dispatch signal informs the passenger alert device vehicle module the identity and location of the passenger, based on the passenger identification information and the location of the passenger alert device station 109. Communication network 113 may be a radio network, a cellular radio network, a satellite communication network or any type of communication network suitable to the necessary communication. Payment information may also be sent to the passenger alert device vehicle module 107. The taxicab having the passenger alert device vehicle module 107 picks up the passenger having the passenger alert device 102 at the passenger alert device station 109 and transports the passenger to their destination. A completed ride signal may be sent from the passenger alert device vehicle module to the passenger alert device network 111 via the communication network 113 to secure payment.

It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. A method for automated location of transportation vehicle passengers comprising the steps of:
activating a transceiver to request a transportation vehicle;
transmitting a request signal upon activation from the transceiver to a transportation server;
sending a location request from the transportation server to a location system;
transmitting an interrogation signal from the location system to the transceiver;
transmitting a response signal from the transceiver to the location system;
processing said response signal to determine the physical location of the transceiver;
sending a pick-up signal to a transportation vehicle to pick up the passenger at the determined physical location.

2. The method of claim 1, wherein said transceiver is a portable device.

3. The method of claim 1, wherein said transceiver transmits radio signals.

4. The method of claim 1, wherein said transportation vehicle is a taxicab.

5. The method of claim 1, wherein said location system is a global positioning system.

6. The method of claim 1, wherein said location system is a cellular network system.

7. The method of claim 6, wherein said cellular network system includes a cell-ID system.

8. The method of claim 6, wherein said cellular network system includes a time of arrival system.

9. The method of claim 7, wherein said time-of-arrival system includes an enhanced time-of-arrival system.

10. The method of claim 1, wherein said location system is a hybrid location system.

11. A system for automated location of transportation vehicle passengers comprising;
a transceiver which transmits a request signal upon activation;
a transportation server which receives said request signal and sends a location request;
a location system which, in response to said location signal determines the location of the transceiver by sending an interrogation signal to the transceiver which responds with a response signal;
wherein said location system sends the determined transceiver location to the transportation server, which sends the determined transceiver location to a transportation vehicle.

12. The system of claim 11, wherein said transceiver is a portable device.

13. The system of claim 11, wherein said transceiver transmits radio signals.

14. The system of claim 11, wherein said transportation vehicle is a taxicab.

15. The system of claim 11, wherein said location system is a global positioning system.

16. The system of claim 11, wherein said location system is a cellular network system.

17. The system of claim 16, wherein said cellular network system includes a cell-ID system.

18. The system of claim 16, wherein said cellular network system includes a time of arrival system.

19. The system of claim 18, wherein said time-of-arrival system includes an enhanced time-of-arrival system.

20. The system of claim 11, wherein said location system is a hybrid location system.
